(19) United States
(12) Patent Application Publication
(10) Pub. No.: US 2004/0175211 A1
(43) Pub. Date: Sep. 9, 2004

(54) Fixing apparatus

(75) Inventors: Toshihiro Sone, Fujieda-shi (JP); Osamu Takagi, Tokyo (JP); Satoshi Kinouchi, Tokyo (JP); Yoshinori Tsueda, Fuji-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/378,859

(22) Filed: Mar. 5, 2003

(51) Int. Cl. G03G 15/20

(52) U.S. Cl. 399/333; 432/60

(57) ABSTRACT

A fixing apparatus comprises a fixing device which fixes a developer image by passing a toner image fixing material between a heating rotary body and a pressing rotary body which are pressed and contacted, wherein at least one of the heating rotary body and pressing rotary body has an elastic foam layer with a rubber hardness of 20-50 degrees, and a conductor layer formed on the surface of the elastic foam layer.

### BACKGROUND OF THE INVENTION

The present invention relates to a fixing apparatus Used in, for example, an image forming apparatus.

As a fixing apparatus of this type, the apparatus disclosed by Jpn. Pat. Appln. KOKAI Publication No. 2002-49261 is known.

This fixing apparatus is provided with a heating roller having a cylindrical rigid body. On the outside of the rigid body, a low heat conduction layer, a conductor layer and a mold releasing layer are sequentially formed.

In the proximity of the heating roller, an induction heating source is provided opposite and close to the mold releasing layer on its outer circumference, so that the conductor layer is inductively heated by the induction heating source.

The thickness of the conductor layer of the heating roller is less than the skin depth which characterizes the depth of a magnetic field to penetrate into the conductor layer, and silicon rubber or silicon rubber foam is used for the low heat conduction layer.

A pressing roller is pressed to the heating roller, a sheet or paper with a toner image on it is fed between the heating roller and pressing roller, so that the paper is heated and pressurized to fix the toner image to the paper.

However, in the prior art, since the hardness (ASCR-C rubber hardness) of the low heat conduction layer of the heating roller is over 45°, when the paper is fed at a low speed and the pressing time is long, characters may collapse.

Further, in the prior art, the paper ejected from the heating roller and pressing roller curls in the toner image stacking direction, winding around the heating roller or causing hot-offset.

Moreover, a heat-resistant adhesive is used to bond the low heat conduction material layer of the heating roller to the conductor layer provided outside of the heating roller. Thus, when the heat-resistant adhesive is degraded, a wrinkle occurs on the surface of the heating roller or the conductor layer is peeled off.

### BRIEF SUMMARY OF THE INVENTION

The present invention has been made to solve the above-mentioned problems. It is an object of the present invention to provide a fixing apparatus which prevents collapse of characters, winding of a fixing material around a heating rotary body, and peeling-off of the conductor layer of the heating rotary body.

According to an aspect of the present invention, there is provided a fixing apparatus comprising a fixing device which fixes a developer image by passing a fixing material with a developer image between a heating rotary body and a pressing rotary body which are pressed and contacted, wherein at least one of the heating rotary body and pressing rotary body has an elastic foam layer with a rubber hardness of 20-50 degrees, and a conductor layer formed on the surface of the elastic foam layer.

According to an embodiment of the present invention, there is provided a fixing apparatus comprising a fixing device which presses a pressing rotary body to a heating rotary body, and fixes a developer image by passing a fixing material with the developer image between these heating rotary body and pressing rotary body; wherein at least one of the heating rotary body and pressing rotary body has an elastic foam layer with a modulus of elasticity of 3.5×10⁻⁴ or less, and a conductor layer formed on the surface of the elastic foam layer.

According to an aspect of the present invention, there is provided a fixing apparatus comprising a fixing device which fixes a developer image by passing a fixing material with a developer image between a heating rotary body and a pressing rotary body which are pressed and contacted, wherein at least one of the heating rotary body and pressing rotary body has an elastic foam layer, and a conductor layer formed on and in one body with the surface of the elastic foam layer.

According to an embodiment of the present invention, there is provided a fixing apparatus comprising a fixing device which presses a pressing rotary body to a heating rotary body, and fixes a developer image by passing a fixing material with a developer image between these heating rotary body and pressing rotary body; wherein at least one of the heating rotary body and pressing rotary body has an elastic foam layer, and a conductor layer formed on the surface of the elastic foam layer, and has different outside diameters at the center in the axial direction and at both ends.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a front view showing a fixing apparatus according to a first embodiment of the present invention;

FIG. 2 is a side view showing the fixing apparatus of FIG. 1;

FIG. 3 is a sectional view showing the structure of a heating roller of FIG. 1;

FIG. 4 is a front view showing a fixing apparatus according to a second embodiment of the present invention;

FIG. 5 is a front view showing a fixing apparatus according to a third embodiment of the present invention;

FIG. 6 is a side sectional view showing a fixing apparatus according to a fourth embodiment of the present invention;

FIG. 7 is side sectional view showing a fixing apparatus according to a fifth embodiment of the present invention;

FIG. 8 is a graph showing the relationship between the hardness of an elastic foam layer constituting the heating roller of FIG. 3, a collapse character occurrence rate and a fixing rate; and

FIG. 9 is a table showing the relationship shown in FIG. 8.

### DETAILED DESCRIPTION OF THE INVENTION

Hereinafter, the present invention will be explained in detail with reference to the embodiments shown in the attached drawings.

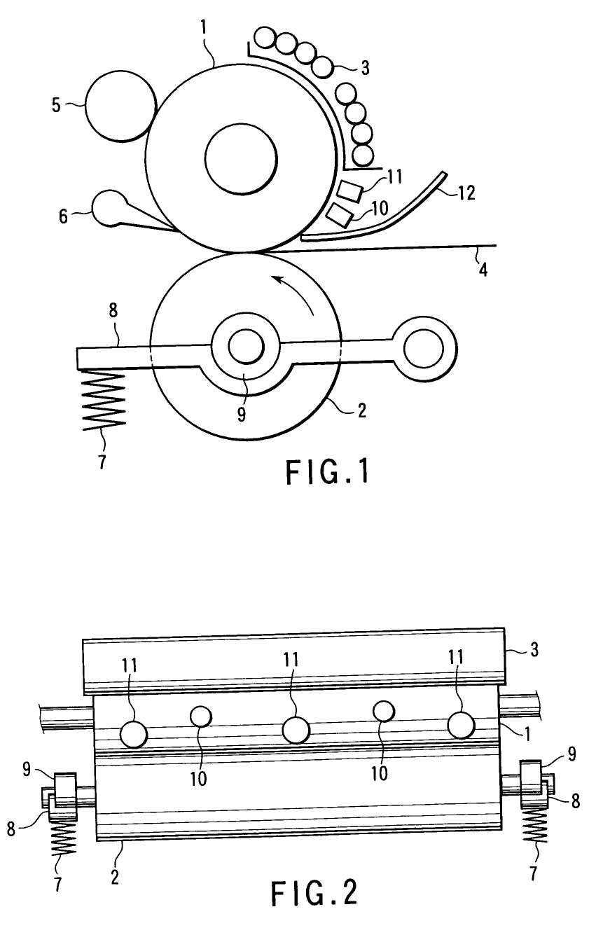

FIG. 1 and FIG. 2 are schematic diagrams showing a fixing apparatus according to a first embodiment of the present invention.

The fixing apparatus is provided with a heating roller (φ40 mm) 1 as a heating rotary body, and a pressing roller (φ40) 2 as a pressing rotary body which is pressed to the lower part of the heating roller (φ40 mm). One of or both the hating roller 1 and pressing roller 2 uses an endless member made of cylindrical elastic material.

The pressing roller 2 is pressed to the heating roller 1 by a press spring 7, and held to have a certain nip width.

The heating roller 1 is rotated by a drive motor (not shown) in the arrow direction, and the pressing roller 2 is rotated in the arrow direction following to the rotation of the heating roller. Paper 4 or a fixing material passes a fixing point that is the contacting part (nip part) between the heating roller 1 and pressing roller 2, so that a developer image on the paper 4 is fused and pressed to fix the image to the paper.

In the circumference of the heating roller 1, a separation claw 6, a cleaning member 5, a thermistor 11 to detect the temperature of the heating roller 1, and a thermostat 10 are sequentially arranged.

The separation claw 6 separates the paper 4 from the heating roller 1. The claw can be omitted if the paper 4 can be separated without the separation claw 6, and contrarily it can be provided in multiple number if the paper 4 cannot be easily separated.

The cleaning member 5 eliminates the toner and paper dust which are offset on the heating roller 1. The thermistor 11 is provided in multiple number in the length direction of the heating roller 1, to detect the temperature of the heating roller 1 and adjust the temperature distribution.

The thermostat 10 is provided at least one on the heating roller 1, and detects abnormality in the surface temperature of the heating roller 1, and interrupts heating.

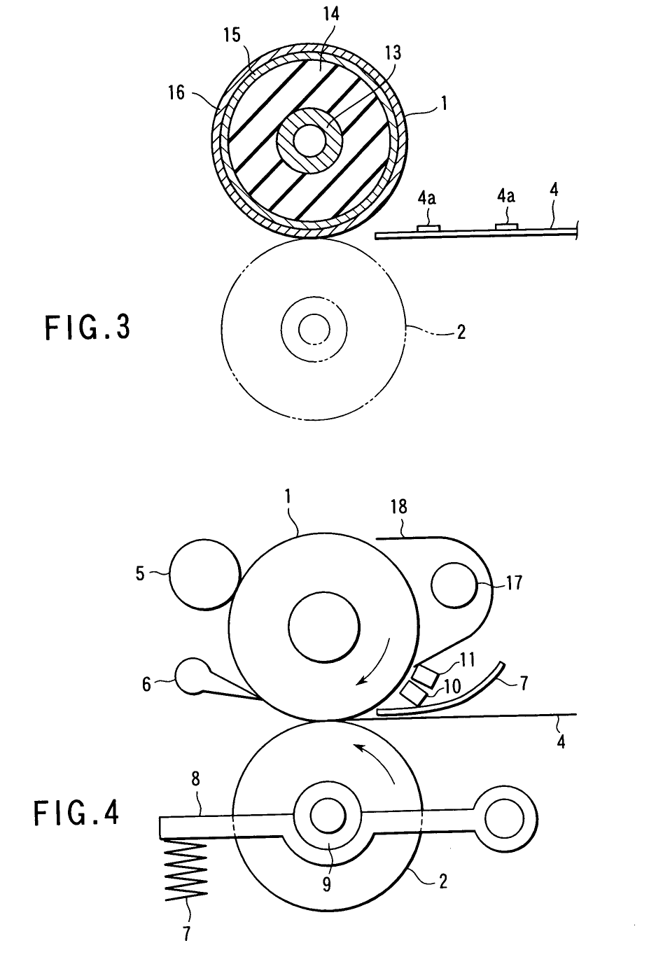

FIG. 3 shows the structure of the heating roller 1 in detail.

The core 13 of the heating roller 1 is metal, and an elastic foam layer 14 is formed outside of the metal core 13. The elastic foam layer 14 has a heat resistance higher than the target temperature. The elastic foam layer 14 also has elasticity, which is foamed with a 20-50° hardness (ASCAR-C rubber hardness), and the modulus of elasticity (Young's modulus) is 3.5×10⁻⁴ or less.

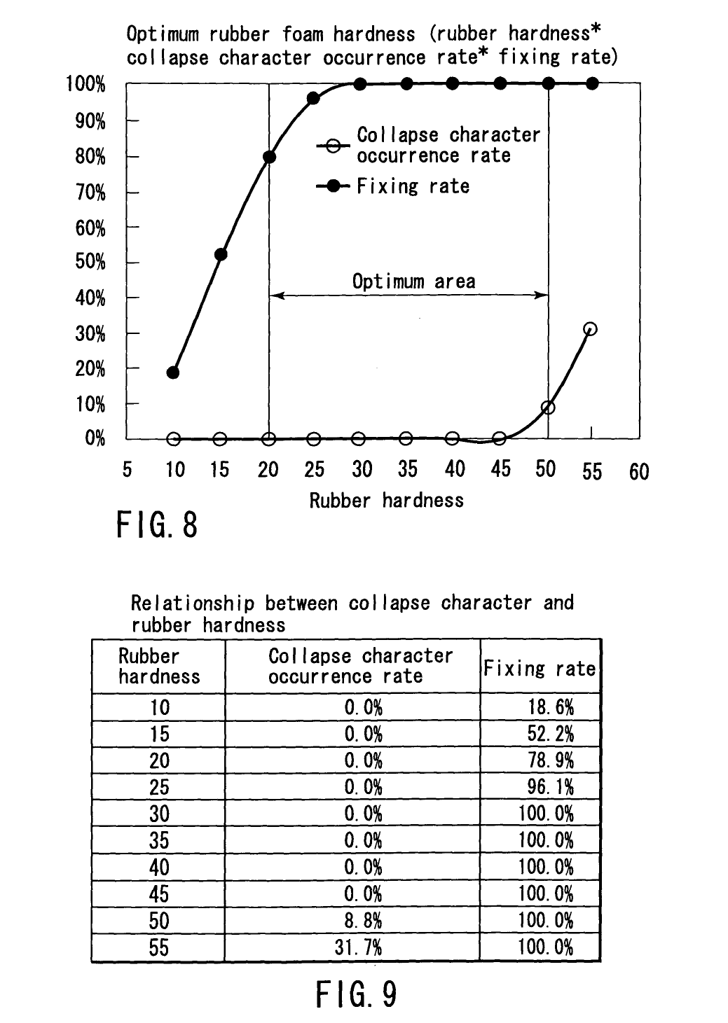

FIG. 8 is a graph showing the relationship between the rubber hardness of the elastic foam layer, the rate of occurrence of collapsed characters, and a fixing rate. FIG. 9 is a table showing the relationship.

As seen from FIG. 8 and FIG. 9, when the hardness of the elastic foam layer 14 is in a range of 20-50 degrees, the fixing rate is over 80% and the collapsed character occurrence rate is below 10%.

When the hardness of the elastic foam layer 14 is in a range of 25-45 degrees, the fixing rate is over 95% and the collapsed character occurrence rate is 0%.

Further, When the hardness of the elastic foam layer 14 is in a range of 30-45 degrees, the fixing rate is 100% and the collapse character occurrence rate is 0%, namely the optimum range.

When the hardness of the elastic foam layer 14 is set to 55 degrees, the transfer toner 4a on the paper 4 is collapsed, and the collapsed character occurrence rate rises to 31.7%.

When the transfer toner 4a on the paper 4 is a layer of multiple color toners, the heating roller 1 is too hard, and the gloss is degraded.

The elastic force of the elastic foam layer 14 to restore to the original form when the pressure is released is the modulus of elasticity of 3.5×10⁻⁴, and no image shift, caused by the fixing toner trailing when the paper is separated after being fixed, occurs.

A conductive layer 15 made of low heat capacity metal is formed outside of and in one body with the elastic foam layer 14. The conductive layer 15 is a thin metal layer. The conductive layer 15 is formed by welding or deposition of thin metal, not by bonding, and has no bonding layer.

The conductive layer 15 can also be formed by precipitation, plating and electro-casting.

The conductive layer 15 is heated upon fixing to a high temperature (about 200°) required in the process of fixing the transfer toner 4a to the paper 4. In the conductive layer 15 bonded with the elastic foam layer 14 with adhesive, when the conductive layer 15 is heated to a high temperature (about 200°), the adhesive layer is deteriorated and the conductive layer 15 is deteriorated. Thus, the surface layer of the heating roller 1 may peel off or become wrinkled, and the image is blurred or shifted when the paper 4 passes through the nip part.

However, in this embodiment, the conductive layer 15 is formed outside of and in one body with the elastic foam layer 14 by welding, for example, without using an adhesive, and the conductive layer 15 is not deteriorated when it is heated to a high temperature, and the above-mentioned problem can be solved.

A separation layer 16 which separates the paper 4 is formed on the outside of the conductive layer 15 of the heating roller 1. The mold releasing layer 16 uses a thin-film silicon layer in this invention, but use of PFA tube or PFA layer is also permitted. The mold releasing layer 16 is needed only when the fixed paper 4 cannot be separated from the heating roller, and it can be omitted.

It is also permitted to configure the pressing roller 2 in the same way as the above-mentioned heating roller 1.

FIG. 4 shows a fixing apparatus according to a second embodiment of the present invention.

The same reference numerals are given to the same components as shown in the above-mentioned first embodiment, and the explanation of these components will be omitted.

In the second embodiment, a heating lamp 17 is used as a heating source of the heating roller, instead of an induction heating unit. In the proximity of the heating lamp 17, a reflector 18 which reflects the heat of the heating lamp 17 to the heating roller 1, is provided.

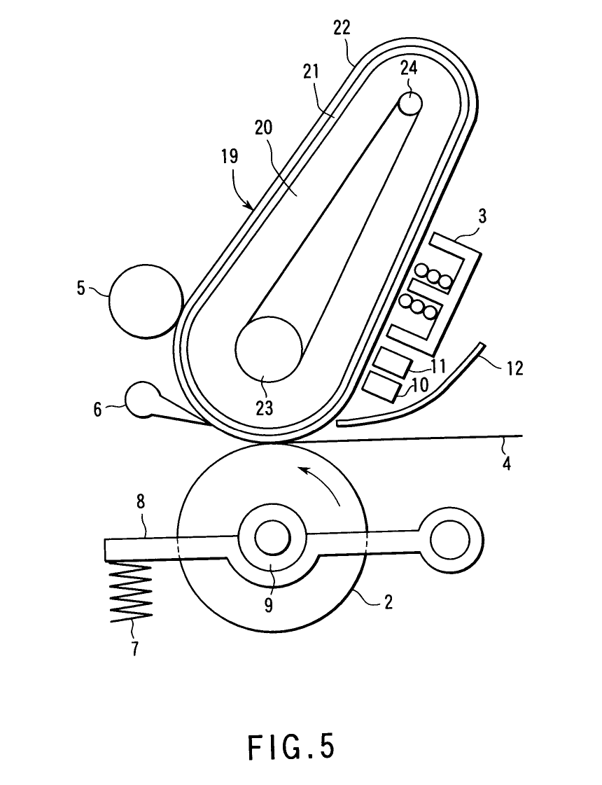

FIG. 5 shows a fixing unit according to a third embodiment of the present invention.

The same reference numerals are given to the same components as shown in the above-mentioned first embodiment, and the explanation of these components will be omitted.

In the third embodiment, a heating belt 19 is used as a heating rotary body, instead of a roller.

The heating belt 19, comprising an elastic foam layer 20, a conductive layer 21 and a separation layer 22, is stretched between the axes 23 and 24, and run by the rotation of the axes.

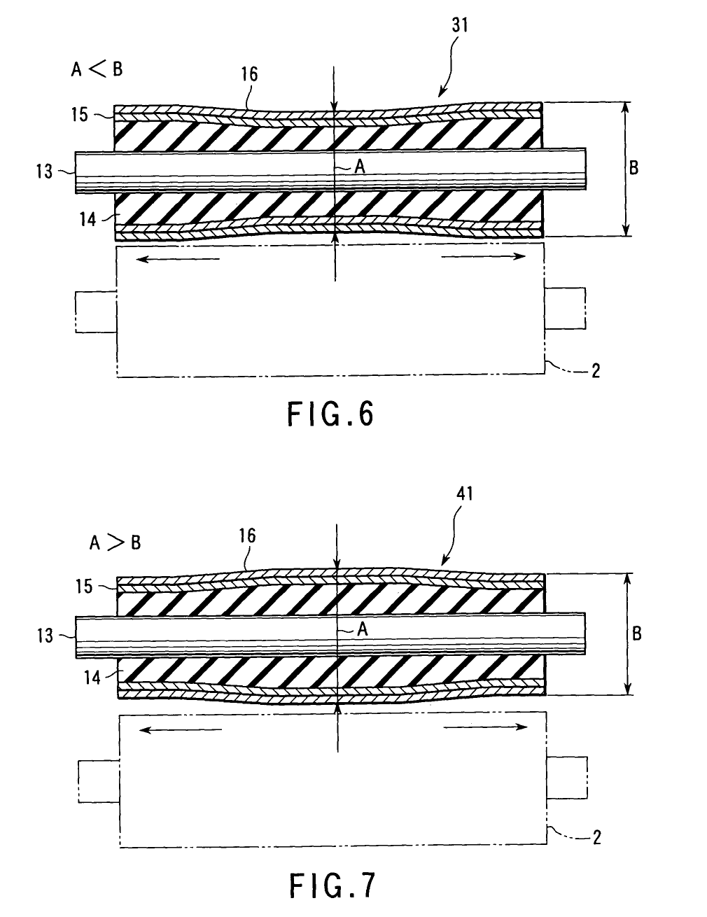

FIG. 6 shows a fixing apparatus according to a fourth embodiment of the present invention.

In this embodiment, a heating roller 31 comprises, like the above-mentioned heating roller 1, a metal core 13, an elastic foam layer 14 formed on the surface of the metal core 13, a conductive layer 15 formed on the surface of the elastic foam layer 14, and a mold releasing layer 16 formed on the surface of the conductive layer 15. However, the outside diameter of the heating roller 31 differs according to the axial direction.

Namely, the outside diameter A at the middle of the heating roller 31 is minimum, the outside diameter increases toward both ends, and the outside diameter B at both ends is maximum.

With this structure, when paper is ejected from the nip part or the contacting part between the heating roller 31 and pressing roller 2, both ends of the paper are pulled in the arrow direction, preventing the paper 4 from being wrinkled or curled.

FIG. 7 shows a fixing apparatus according to a fifth embodiment of the present invention.

The same reference numerals are given to the same components as shown in the above-mentioned fourth embodiment, and the explanation of these components will be omitted.

In the fifth embodiment, the outside diameter A at the middle of the heating roller 41 is maximum, the outside diameter decreases toward both ends, and the outside diameter B at both ends is minimum.

With this structure, when the paper 4 is ejected from the nip part or the contacting part between the heating roller 41 and pressing roller 2, both ends of the paper are pulled in the arrow direction, preventing the paper 4 from being wrinkled or curled.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fixing apparatus comprising:
a fixing device which fixes a developer image by passing a fixing material with a developer image between a heating rotary body and a pressing rotary body which are pressed and contacted; wherein
at least one of the heating rotary body and pressing rotary body has an elastic foam layer with a rubber hardness of 20-50 degrees, and a conductor layer formed on the surface of the elastic foam layer.

2. The fixing apparatus according to claim 1, wherein a heat-resistant mold releasing layer is formed on the surface of the conductor layer.

3. The fixing apparatus according to claim 1, wherein the heat conductivity of the elastic foam layer is 0.25 W/m×k or less.

4. A fixing apparatus comprising:
a fixing device which fixes a developer image by passing a fixing material with a developer image between a heating rotary body and a pressing rotary body which are pressed and contacted; wherein
at least one of the heating rotary body and pressing rotary body has an elastic foam layer with a modulus of elasticity of 3.5×10⁻⁴ or less, and a conductor layer formed on the surface of the elastic foam layer.

5. The fixing apparatus according to claim 4, wherein a heat-resistant mold releasing layer is formed on the surface of the conductor layer.

6. The fixing apparatus according to claim 4, wherein the heat conductivity of the elastic foam layer is 0.25 W/m×k or less.

7. A fixing apparatus comprising:
a fixing device which fixes a developer image by passing a fixing material with a developer image between a heating rotary body and a pressing rotary body which are pressed and contacted, wherein
at least one of the heating rotary body and pressing rotary body has an elastic foam layer, and a conductor layer formed on and in one body with the surface of the elastic foam layer.

8. The fixing apparatus according to claim 7, wherein the conductor layer is a thin metal and formed in one body with the elastic foam layer by welding or deposition.

9. The fixing apparatus according to claim 7, wherein the conductor layer is formed in one body with the elastic foam layer by precipitation, plating or electro-casting.

10. The fixing apparatus according to claim 7, wherein a heat-resistant mold releasing layer is formed on the surface of the conductor layer.

11. The fixing apparatus according to claim 7, wherein the heat conductivity of the elastic foam layer is 0.25 W/m×k or less.

12. A fixing apparatus comprising:
a fixing device which fixes a developer image by passing a fixing material with a developer image between a heating rotary body and a pressing rotary body which are pressed and contacted; wherein
at least one of the heating rotary body and pressing rotary body has an elastic foam layer, and a conductor layer formed on the surface of the elastic foam layer, and has different outside diameters at the center in the axial direction and at both ends.

13. The fixing apparatus according to claim 12, wherein the outside diameter of at least one of the heating rotary body and the pressing rotary body is minimum at the center in the axial direction, and increases toward both ends.

14. The fixing apparatus according to claim 12, wherein the outside diameter of at least one of the heating rotary body and the pressing rotary body is maximum at the center in the axial direction, and decreases toward both ends.

15. The fixing apparatus according to claim 12, wherein a heat-resistant mold releasing layer is formed on the surface of the conductor layer.

16. The fixing apparatus according to claim 12, wherein the heat conductivity of the elastic foam layer is 0.25 W/m×k or less.
